(19) United States
(12) Patent Application Publication
(10) Pub. No.: US 2020/0108294 A1
(43) Pub. Date: Apr. 9, 2020

(54) Belay Loop

(71) Applicant: Black Diamond Equipment, Ltd., Salt Lake City, UT (US)

(72) Inventors: Christopher Andrew Nance, Highland, UT (US); Thomas Zebulon Franke, Salt Lake City, UT (US)

(21) Appl. No.: 16/153,984

(22) Filed: Oct. 8, 2018

(51) Int. Cl. A63B 29/02; A62B 35/00

(52) U.S. Cl. CPC A63B 29/02; A62B 35/0037; B32B 7/08; A62B 35/0031; A62B 35/0075

(57) ABSTRACT

A load bearing belay loop includes a load bearing inner structural ring that is formed by winding a single filament in many windings to form a coil, and an outer sheath made from a sheet material that is tubular in configuration and that is rolled axially to cover the ring. The outer sheath is not load bearing. The inner ring may be formed by winding a single filament in many windings to form a coil.

### BACKGROUND OF THE INVENTION

A climbing harness typically includes a belay loop that physically interconnects the waist belt and the leg loops. The belay loop is also used to receive a carabiner for use in belaying or rappelling situations. The belay loop must be strong enough to support the climber's weight not only in a static situation but also in the event of a fall.

Some belay loops are constructed to have a flat cross-sectional configuration, with angular or squared-off edges. Such edges can sometimes cause abrasion at points where the belay loop connects with the other parts of the harness. It would be desirable to construct a belay loop in a manner so as to minimize abrasion between the belay loop and the other harness parts.

In addition, a belay loop that is not uniform in thickness and/or width and/or stiffness can be problematic, in use. For example, a belay loop that is stiffer at one point around its circumference will tend to take a set, that is, the rope or carabiner hook will tend to engage the belay loop at the same place along the circumference of the belay loop every time because the stiffer portions of the belay loop push it away. This can cause the belay loop to wear more rapidly at a given point, which is not desirable.

US Patent Application Publication No. 2015/0352407 discloses a webbing loop for use by a climber, that is made from two basic components sewn together. The first component is an inner ring that is made of multiple windings of a strong, filamentary material. The filamentary material can be any one of a number of different materials, including but not limited to nylon, liquid crystal polymer, polyester, and/or polyethylene fibers. Particular examples of suitable fiber materials are sold under the brand names of Vectran®, Spectra®, and Dyneema®. An outer sheath of fabric material is wrapped around the inner ring, to protect the inner ring. The outer sheath is initially formed as a flat piece of material, in the form of an elongate rectangle. The flat piece of material is formed into a tubular shape (see FIG. 1) with the two long edges abutting each other with a slit between them. The tubular piece is then bent into a C-shaped configuration as it is wrapped around the inner ring by inserting the inner ring through the slit. The tubular outer sheath is long enough so that the ends overlap. The overlapping ends are sewn together to fully enclose the inner ring. In the finished product, the outer sheath is thicker where its ends overlap. In addition, there are ridges at the locations of the end surfaces, which can also cause abrasion. In a commercial product made in accordance with this disclosure, a woven material (biaxially braided material) is used for the outer sheath.

U.S. Pat. No. 8,292,029 discloses a piece of biaxially braided material that is formed in a tubular configuration then rolled up from one end to the other. The material is then secured by sewing, with the result being a ring-shaped object that has no transverse ridges or thickened areas around its circumference. The patent states that this construction can be used as a belay loop, but a fabric loop made in this manner elongates so much under load that it cannot possibly be used alone as a belay loop in a climbing harness.

### SUMMARY OF THE INVENTION

In one embodiment, the present invention relates to a load bearing belay loop, including a load bearing inner structural ring, and an outer sheath made from a sheet material that is tubular in configuration and that is rolled axially to cover the ring, and in which the outer sheath is not load bearing.

In another embodiment, the invention relates to a method of making a load bearing belay loop. The method includes the steps of making a load bearing inner structural ring; providing an outer sheath that is made from a sheet material and that is tubular in configuration extending axially between a first end and a second end, wherein the outer sheath is not load bearing; covering the inner ring by rolling the tubular sheath axially onto the inner ring; and closing the rolled sheath to contain the inner ring.

In one embodiment, the inner structural ring that is formed by winding a single filament in many windings to form a coil.

### BRIEF DESCRIPTION OF THE DRAWINGS

Further features of the invention will become apparent to one of ordinary skill in the art to which the invention pertains from a reading of the following specification together with the accompanying drawings, in which:

FIG. 1 is a pictorial illustration of a climbing harness including a belay loop in accordance with the present invention;

FIG. 2 is an enlarged pictorial view of a portion of the harness of FIG. 1 including the belay loop;

FIG. 3 is a pictorial view of an inner structural ring that is a first component of the belay loop;

FIG. 4A is a view of a protective sheath that is a second component of the belay loop, placed alongside the inner structural ring;

FIG. 4B is an illustration of the relative position of the two components of the belay loop at an initial point in the process of manufacture of the belay loop;

FIG. 5 is a perspective view of the completed belay loop;

FIG. 6 is a schematic sectional view through the completed belay loop, taken generally along line 6-6 of FIG. 5;

FIG. 7 is a graph illustrating comparative results of load testing of the individual component parts of the belay loop of FIG. 1 as well as of the belay loop itself;

FIG. 8 is a pictorial view of an inner structural ring of a belay loop that is another embodiment of the invention; and

FIG. 9 is a pictorial view of an inner structural ring of a belay loop that is still another embodiment of the invention

### DETAILED DESCRIPTION

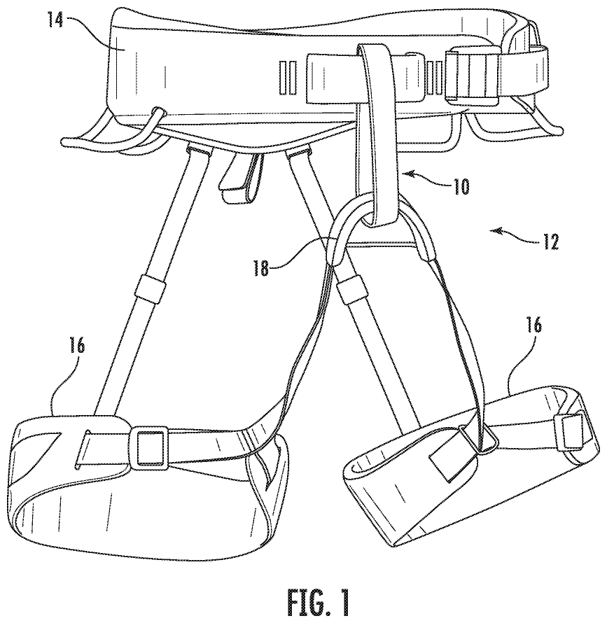

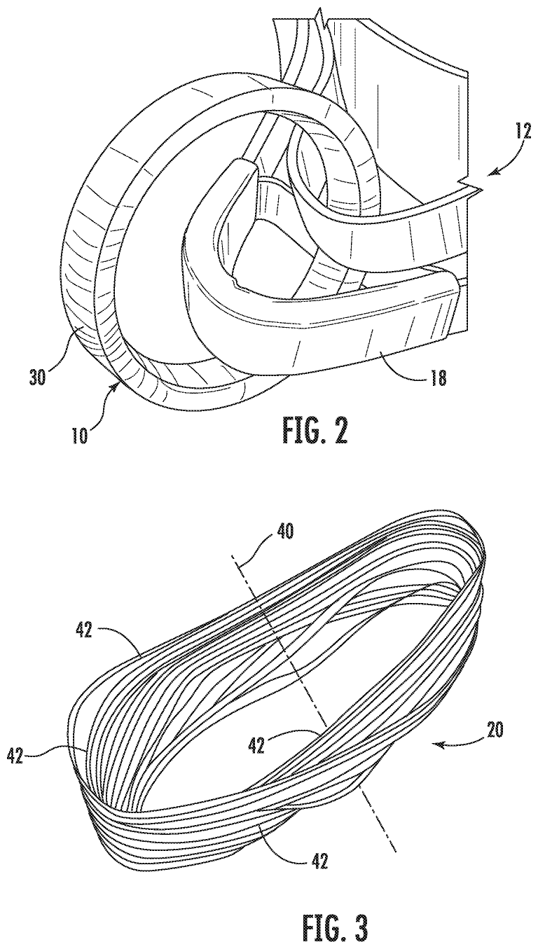

The present invention relates to a belay loop. In particular, the present invention relates to a belay loop that is constructed with a load bearing inner structural ring and a non load bearing protective sheath. The invention is applicable to belay loops of different and varying constructions. As representative of the invention, FIG. 1 illustrates a belay loop 10 that is a first embodiment of the invention.

The loop 10 forms part of a climbing harness 12. The harness 12 includes a waist belt 14 and two leg loops 16 connected by a leg loop cross piece 18. The belay loop 10 may be used to attach a carabiner to the hamess to enable the user to belay or rappel. With the exception of the belay loop 10, the parts of the harness 12 are conventional and are therefore not described in detail.

The belay loop 10 is constructed from two components or parts that are joined together by stitching in a manner as described below. The two components are an inner ring 20 and an outer sheath 30. The inner ring 20 is the structural or load-bearing part of the loop 10. The outer sheath 30 serves to protect the inner ring 20 and to limit abrasion between the inner ring and the other parts of the harness 12. The outer sheath 30 is not load bearing.

The inner ring 20 is load bearing—that is, it is constructed to meet the functional requirements of a belay loop. Specifically, it is strong enough to carry the loads, both static and dynamic, that can be experienced by a belay loop when in use, without significant elongation or other detrimental effects that would adversely affect the functioning of the belay loop. In particular, the inner ring 20 is constructed to meet the 15 kN (3,372 pounds) minimum strength requirement of the climbing standard (EN 12277). In contrast, the other component of the belay loop 10, the outer sheath 30, is not load bearing; that is, it cannot meet these functional requirements.

The inner ring 20 is flexible, not rigid, so as to perform better as part of a climbing harness that is otherwise made from flexible materials. Another desirable characteristic of the inner ring 20 is that it should be as light in weight as is feasible, while still maintaining the needed strength.

Various different configurations are available for an inner ring that meets these structural requirements. One preferred configuration for the inner ring is a winding or coil of filamentary material (a long strand, for example), as in the embodiment illustrated in FIGS. 3-7. This configuration provides a pliable construct which is strong enough when a suitable material is selected. The filamentary material can be any one of a number of different materials, including but not limited to nylon, liquid crystal polymer, polyester, and/or polyethylene fibers. Particular examples of suitable fiber materials are sold under the brand names of Vectran®, Spectra®, and Dyneema®. Other materials would also be suitable.

In the embodiment of FIGS. 3-7, the inner ring 20 (FIG. 3) is constructed from a single filamentary material that is wound a plurality of times about an axis or center 40 to form the inner ring. The inner ring 20 is formed in a size that is appropriate to form a belay loop 10, for example, in the range of from about 2½″ to about 3½″ in diameter when in a circular configuration. The wound inner ring 20 may have a cross-sectional diameter (if circular or approximately circular) of about one quarter inch. The number of windings 42 will depend on the filamentary strength of the chosen material and the load-bearing requirement of the belay loop 10. In one embodiment, the inner ring 20 is formed as a coil having about 50 to 200 windings 42.

The inner ring 20 as thus formed (and when the windings are held together as a group) is suitable, alone, to perform the load-bearing functions of the belay loop 10. Nevertheless, the inner ring 20 should be protected from the elements, and from contact with the other parts of the harness 12. In addition, it is conceivable that the inner ring 20 may under load assume a configuration (such as a cross-sectional configuration) that presents one or more sharp edges or narrow areas to its adjoining harness parts, undesirably increasing the surface pressure at one or more locations, and thus tending to cause abrasion of the adjoining harness parts. To avoid this occurrence, the inner ring 20 is, as described below, assembled with the protective sheath or outer sheath 30.

In the illustrated embodiments, the outer sheath 30 is made from an extruded tubular fabric as discussed above, cut to a length of, for example, four to five inches. The fabric can be made from any one of a number of different materials, including but not limited to nylon, liquid crystal polymer, polyester, and/or polyethylene fibers. Particular examples of suitable fiber materials are sold under the brand names of Vectran®, Spectra®, and Dyneema®. Other materials would also be suitable. The length of the tube is selected so that the tube can be wrapped around the inner ring 20 the desired number of times and then sewn down or otherwise secured as described below. The diameter of the tube is selected so that the overall dimensions of the rolled tube are roughly the desired dimensions of the finished loop 10. The tube is preferably seamless, in a cylindrical configuration centered on an axis 40.

The fabric of the sheath 30 can be of any one of various different constructions, for example, knitted, or woven, or braided. It is helpful to have some axial flexibility to aid in the rolling stage of the assembly process. Axial flexibility can be achieved by using a knit fabric, or a woven fabric, or a braided tube. By itself, of course, a tube with significant axial stretch would not function as a belay loop since it would have too much elongation.

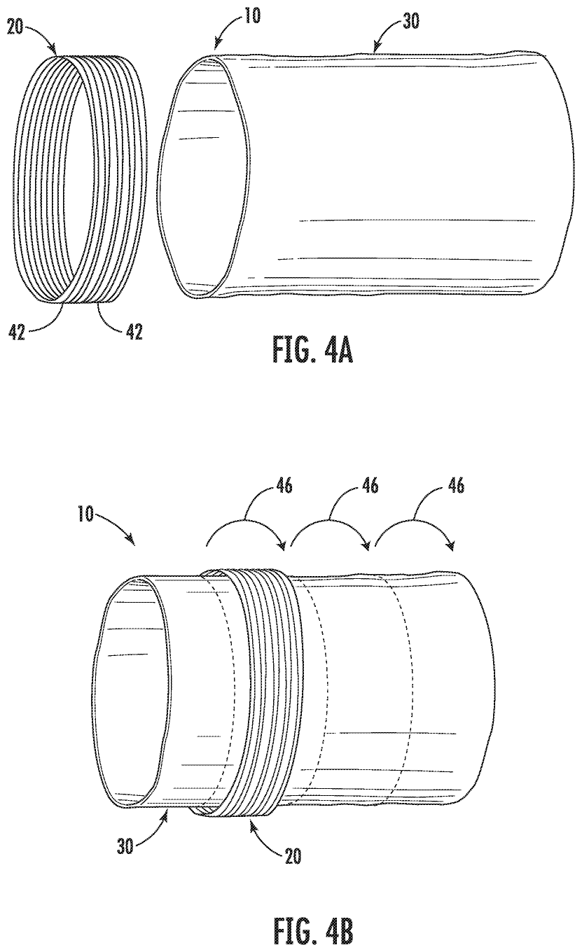

In assembly of the particular belay loops that are illustrated, the inner ring 20 is formed separately, then the sheath 30 is placed in its unrolled tubular configuration as shown schematically in FIG. 4B. This process is illustrated schematically in FIGS. 4-6.

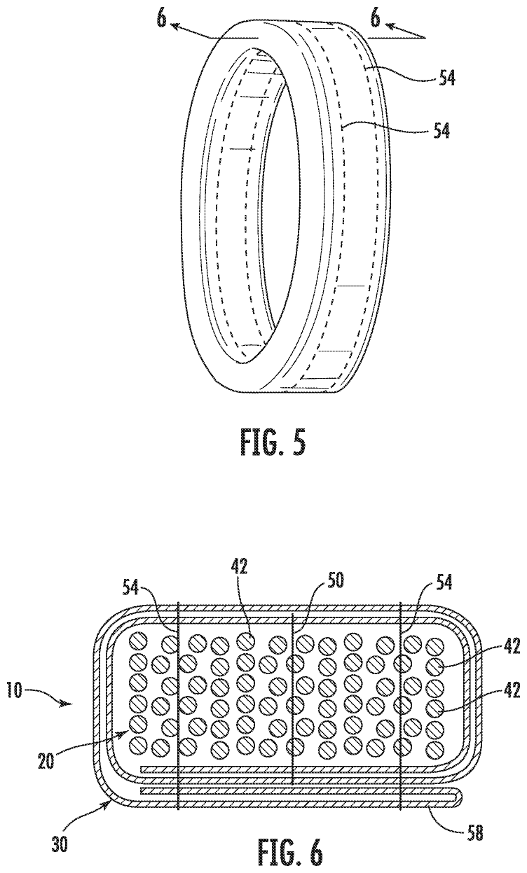

Specifically, the inner ring 20 is placed around one end of the tubular outer sheath 30. Then, the outer sheath 30 is rolled up axially from one end, over the filaments, until it is wrapped a number of times around the wound filaments 42. This rolling process is similar to what happens when rolling up a shirt sleeve, for example, and is illustrated by the arrows 46 in FIG. 5.

In the illustrated embodiment, the sheath 30 is rolled up around the wound filaments 42 about two and a half times, to create more than two full wraps of sheath material around the core inner ring 20 (see FIG. 6). The sheath 30 is not folded, but is rolled instead.

Applicant has found that fewer than two wraps of sheath material 30 around the ring may not be sufficient to fully secure the inner ring 20 as needed. Three or more wraps of sheath material 30 has been found to be unnecessary and to add unneeded bulk. In a preferred embodiment, as illustrated in the drawings, about 2.5 wraps are provided.

The assembled inner ring 20 and outer sheath 30 are then formed into the finished belay loop 10 by securing the outer sheath closed around the inner ring. In the illustrated embodiment, this securing is accomplished by sewing the two components together. However, assembly methods other than sewing could be used, for example lamination of the outer sheath, so long as the outer sheath is prevented from opening up.

Specifically, in the illustrated embodiment, an initial circular stitching section 50 is placed through the sheath 30 and the inner ring 20 also, after about one to one a half wraps of the sheath around the inner ring. This stitching section 50 extends circumferentially around the entire circular extent of the belay loop 10, approximately in the lateral center. Then the wrapping of the sheath 30 on the inner ring 20 is continued and completed, with the terminal end portion of the sheath being folded inside itself as shown at 52. Then two additional circular stitching sections 54 are employed, each extending circumferentially around along the perimeter of the belay loop 10. Other sewing processes are possible, for example, sewing the sheath closed around the first wrap without sewing through the inner ring filaments, then continuing the wrapping.

When the belay loop 10 is thus assembled and used as a component of the climbing harness, the inner ring 20 is completely enclosed in the sheath 30. The sheath 30 prevents contact between the inner ring 20 and the other parts of the harness. In addition, the sheath 30, by virtue of its rolled configuration, causes the belay loop 10 to present a smooth surface to the adjoining parts of the harness 12, which smooth surface minimizes the surface pressure of the inner ring on the other harness parts. There are no ridges or lap joints around the circumference of the belay loop 10. This is in contrast to a folded sheath 30, such as the sheath in the aforementioned US Patent Application Publication No. 2015/0352407. The minimization of pressure points on the other harness parts, together with the large load-bearing capacity of the inner ring 20, provides a belay loop 10 that is a significant improvement on the prior art belay loops.

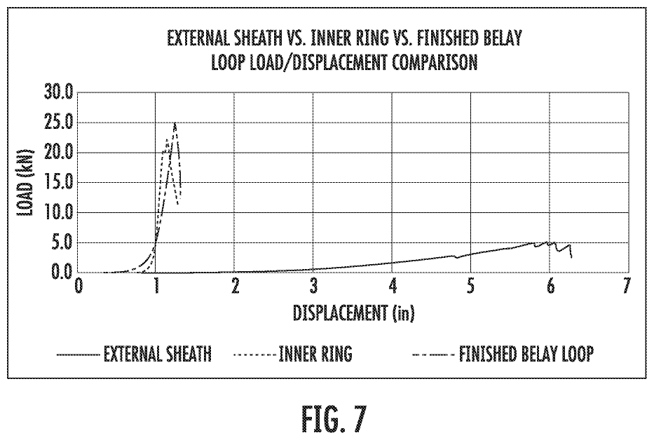

FIG. 7 is a graph illustrating the results of elongation testing of examples of the inner ring 20 alone, the sheath 30 alone, and the completed belay loop 10. Load is measured on the vertical (y) scale, and displacement under load is measured on the horizontal (x) scale. It can be seen that the inner ring 20 alone assumes a high load with minimal displacement. The curve for the complete belay loop 10 including the inner ring 20 and the outer sheath 30 is almost identical to that of the inner ring alone. In contrast, the sheath 30 alone undergoes a very large amount of displacement without ever assuming a significant amount of load. This is substantially more displacement than is acceptable in a useful belay loop. So, the sheath 30 cannot be said to be load bearing.

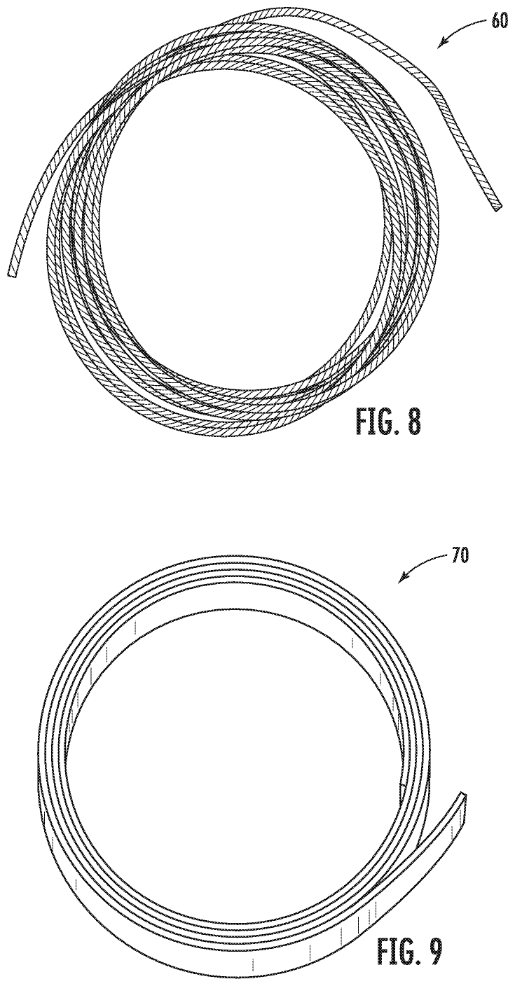

FIGS. 8 and 9 illustrate alternative embodiments of the inner ring of the inventive belay loop. The inner ring 60 (FIG. 8) is a braided cord (bundles of filament braided together to create cord). This thin braided cord could function as the inner structural ring of the belay loop 10. Since the braided cord 60 is stronger than a single filament, it would likely need fewer wraps to achieve the needed structural load requirement of 15 kN, possibly as few as ten wraps or less. This thin braided cord is small enough that ho hard spot or lump would be felt at the start/stop of the cord.

The inner ring 70 (FIG. 9) is a thin webbing (bundles of filament woven together to create webbing. This thin coiled webbing could function as the inner structural ring of the belay loop 10. Since the webbing 70 is stronger than a single filament, it would likely need fewer wraps to achieve the needed structural load requirement of 15 kN, possibly as few as ten wraps or less. This webbing is thin small enough that ho hard spot or lump would be felt at the start/stop of the webbing.

The foregoing examples contemplate the use of a filamentary material as (or as the basis for) the inner structural ring. It should be understood that the invention is broader, and thus is not limited to having the inner structural ring be only a filamentary based structure. An extruded plastic, for example, could be used as well.

It can thus be seen that the assembly of the inner structural ring 20 with the sheath 30 is significantly better than the sheath alone at performing the structural functions of the belay loop 10—that is, connecting the leg loops 16 while also bearing any belaying load, static or dynamic, without significant elongation or other detrimental effects that would adversely affect the functioning of the belay loop. The minimization of pressure points on the other harness parts, arising from the rolled construction of the outer sheath 30, is combined with the large load-bearing capacity of the inner ring 20, to provide a belay loop 10 that is a significant improvement on the prior art belay loops.

From the above description of the invention, those skilled in the art will perceive improvements, changes and modifications in the invention. Such improvements, changes and modifications within the skill of the art are intended to be covered by the appended claims.

1. A load bearing belay loop, comprising:
a load bearing inner structural ring; and
an outer sheath made from a sheet material that is tubular in configuration and that is rolled axially to cover the inner ring, wherein the outer sheath is not load bearing.

2. A belay loop as set forth in claim 1 wherein the inner ring is constructed to meet the 15 kN (3,372 pounds) minimum strength requirement of the climbing standard (EN 12277), and the outer sheath alone does not meet this functional requirement.

3. A belay loop as set forth in claim 1 that forms part of a climbing harness that includes a waist belt and two leg loops connected by a leg loop cross piece.

4. A belay loop as set forth in claim 1 wherein the inner structural ring is formed by winding a single filament in many windings to form a coil.

5. A belay loop as set forth in claim 4 wherein the single filament is made from any one of a number of strong but pliant materials including but not limited to nylon, liquid crystal polymer, polyester, and/or polyethylene fibers.

6. A belay loop as set forth in claim 4 wherein the inner ring is formed as a coil having about 50 to 200 windings of filamentary material.

7. A belay loop as set forth in claim 1 wherein the tubular sheath is rolled one wrap onto the inner ring then secured closed around the inner ring, then the tubular sheath is rolled at least one additional wrap onto the inner ring and then secured closed around the inner ring and around the first wrap.

8. A belay loop as set forth in claim 1 having a smooth outer surface with no ridges or lap joints around the circumference of the belay loop.

9. A belay loop as set forth in claim 1 wherein the load bearing capacity before elongation of the belay loop is substantially the same as the load bearing capacity before elongation of the inner ring alone.

10. A load bearing belay loop as set forth in claim 1 wherein:
the inner ring is constructed to meet the 15 kN (3,372 pounds) minimum strength requirement of the climbing standard EN 12277, and the outer sheath alone does not meet this functional requirement;
wherein the belay loop that forms part of a climbing harness that includes a waist belt and two leg loops connected by a leg loop cross piece;
wherein the single filament is made from any one of a number of strong but pliant materials including but not limited to nylon, liquid crystal polymer, polyester, and/or polyethylene fibers, and the inner ring is formed as a coil having about 50 to 200 windings of filamentary material;
wherein the tubular sheath is rolled one wrap onto the inner ring then secured closed around the inner ring, then the tubular sheath is rolled at least one additional wrap onto the inner ring and then secured closed around the inner ring and around the first wrap; and
the belay loop has a smooth outer surface with no ridges or lap joints around the circumference of the belay loop.

11. A belay loop as set forth in claim 1 wherein the inner structural ring is formed by winding multiple filaments into a single braided cord.

12. A belay loop as set forth in claim 1 wherein the inner structural ring is formed by weaving bundles of filament together to create a thin webbing.

13. A method of making a load bearing belay loop, the method comprising the steps of:
making a load bearing inner structural ring by winding a filament in many windings to form a coil;
providing an outer sheath that is made from a sheet material and that is tubular in configuration extending axially between a first end and a second end, wherein the outer sheath is not load bearing;
covering the inner ring by rolling the tubular sheath axially onto the inner ring; and
securing the sheath closed to contain the inner ring;

14. A method as set forth in claim 13 wherein the outer sheath is seamless.

15. A method as set forth in claim 14 wherein the step of covering the inner ring includes the steps of:
rolling the tubular sheath one wrap onto the inner ring;
securing the one wrap of tubular sheath closed around the inner ring;
rolling the tubular sheath at least one additional wrap onto the inner ring; and
securing the at least one additional wrap of tubular sheath closed around the inner ring and around the first wrap.

16. A method as set forth in claim 15 wherein the securing steps comprise sewing.

17. A method as set forth in claim 16 wherein the outer sheath is made from a knitted or woven fabric.
